(19) United States
(12) Patent Application Publication
(10) Pub. No.: US 2025/0189086 A1
(43) Pub. Date: Jun. 12, 2025

(54) MONITORING PIPELINE INTEGRITY USING MACHINE LEARNING AIDED FIBER-OPTIC DISTRIBUTED ACOUSTIC SENSING

(71) Applicants: Saudi Arabian Oil Company, Dhahran (SA); King Abdullah University of Science and Technology, Thuwal (SA)

(72) Inventors: Abderrahim Fakiri, Dhahran (SA); Shaj K. Manjalivalapil, Abqaiq (SA); Juan M. Marin, Thuwal (SA); Islam Ashry, Thuwal (SA); Boon Siew Ooi, Thuwal (SA)

(21) Appl. No.: 18/535,632

(22) Filed: Dec. 11, 2023

(51) Int. Cl. F17D 5/06; G01H 9/00

(52) U.S. Cl. CPC F17D 5/06; G01H 9/004

(57) ABSTRACT

A method for monitoring pipeline integrity is provided. The method includes obtaining, using at least one hardware processor, acoustic signal captured by at least one optical fiber arranged along a pipeline. The method includes inputting, using the at least one hardware processor, the acoustic signal to a machine learning model. The machine learning model is trained to execute a first analysis on a first representation of the acoustic signal and a second analysis on a second representation of the acoustic signal, the first analysis being independent to the second analysis. An output of the trained machine learning model is at least one of a first result based on the first analysis or a second result based on the second analysis. The method includes determining, using the at least one hardware processor, an indication of pipeline integrity based on the at least one of the first result or the second result.

### BACKGROUND

Pipelines are used in the oil and gas industry for transporting oil and gas over long distances. Due to corrosion and other factors, pipelines can deteriorate over time. One form of deterioration is metal loss, which can result in thinner walls of the pipelines than needed for safe operation, potentially leading to structural fault of the pipelines and reducing pipeline integrity. Metal loss from the inside of pipelines can be hard to detect, especially at locations wrapped from outside by composite protective sleeves.

### BRIEF DESCRIPTION OF THE DRAWINGS

FIG. 1 illustrates an example system for monitoring pipeline integrity using machine learning aided distributed acoustic sensing (DAS), according to some embodiments.

FIG. 2 illustrates an example DAS unit, according to some embodiments.

FIGS. 3A and 3B each illustrate an example branch of a convolutional neural network (CNN) for determining pipeline integrity, according to some embodiments.

FIG. 4 illustrates an example schematic diagram for simulating the acoustic behavior of a pipeline with different degrees of metal loss, according to some embodiments.

FIG. 5 illustrates example simulation results of sound pressure levels (SPLs) for pipes with different degrees of metal loss, according to some embodiments.

FIG. 6 illustrates example simulation results of energy contribution per frequency band for pipes with different degrees of metal loss, according to some embodiments.

FIG. 7 illustrates an example graph showing the relationship between energy contribution and metal loss for band 6, according to some embodiments.

FIG. 8 illustrates a flowchart of an example method, according to some embodiments.

FIG. 9 illustrates hydrocarbon production operations, according to some embodiments.

FIG. 10 is a block diagram of an example computer system, according to some embodiments.

Figures are not drawn to scale. Like reference numbers refer to like components.

### DETAILED DESCRIPTION

Embodiments described herein determine an indication of pipeline integrity using machine learning aided fiber-optic distributed acoustic sensing (DAS). Metal loss and structural faults in metal components (e.g., pipes) of a pipeline are monitored to maintain pipeline integrity and operation safety. Traditionally, non-destructive testing (NDT) methods to determine pipeline integrity such as ultrasonic testing radiography, and pulsed eddy current, are not suitable for underground or other hard-to-reach locations as they may require excavation and scaffolding. These methods are also not suitable for use in repair locations along a pipeline (e.g., locations having composite sleeves wrapping around metallic pipeline) and have difficulty in supporting continuous monitoring. In-line-inspection (ILI), on the other hand, often is either unable to sufficiently cover a long range of pipelines, unable to detect small defects due to limited resolution, not suitable for real-time monitoring, or cost-ineffective. ILI may also need launchers and receivers installation to operate, which many pipelines, especially non-piggable pipelines, are not equipped with.

Fiber-optic DAS improves upon traditional approaches by, for example, enabling continuous monitoring of pipeline integrity, including at locations where repairs have occurred. Typically, when oil and gas fluid flows inside a pipeline, the collision between the fluid and inner surface of the pipeline causes vibrations of the pipeline. The vibrations cause the generation of acoustic signals that are propagated through the pipeline wall and captured by one or more optical fibers located near of physically coupled with the pipeline. Because acoustic signal signatures are sensitive to metal losses and other types of structural changes on a pipeline, a structural change at a location on the pipeline may alter the captured acoustic signals, and the change in the acoustic signals can be captured by fiber-optic DAS. As such, DAS enables detection of metal losses that are very minor (e.g., slight, early stage metal loss). Early stage metal loss is undetectable using traditional monitoring approaches. In addition, a DAS system has a sensing range of 10 kilometers or more, which makes DAS cost-effective to simultaneously monitor multiple locations on the metallic structure of a long pipeline without being hindered by physical settings, such as insulation, coating, or sleeves, at the monitored locations. The sensing range refers to locations along the pipeline where acoustic signal is captured by the DAS system. In embodiments, a fiber-optic DAS system locates the source of acoustic signals along the pipeline using the optical fiber associated with locations of the pipeline, and determines the frequency of the acoustic signal.

The present disclosure utilizes the advantages of DAS to improve upon traditional pipeline integrity monitoring techniques. As described in detail below, embodiments of the present disclosure employ a DAS system that collects (e.g., using the optical fiber coupled to a DAS unit) acoustic signal sensed along a pipeline. The DAS system then processes (e.g., using a hardware processor) the collected signals using a trained machine learning model to identify and quantify metal losses in particular locations along the pipeline. Based on the monitoring results, the DAS system can evaluate the risk of structural fault and urgency of any repair and prompt maintenance personnel to take actions accordingly, such as acquiring replacement parts in anticipation of upcoming damages, shutting down the pipeline immediately in response to detected damages, or rescheduling an upcoming maintenance upon detecting less-than-expected pipeline metal loss. With one or more features described below, embodiments of the present disclosure improve the accuracy and timeliness of pipeline integrity monitoring, and thereby improve the operation safety and cost-effectiveness in the energy transportation industry.

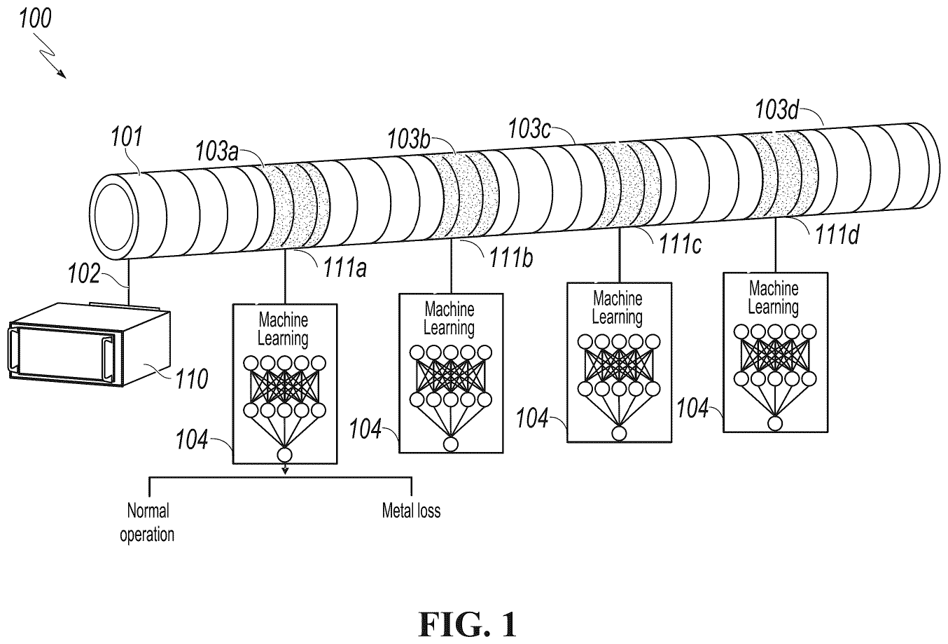

FIG. 1 illustrates an example system 100 for monitoring pipeline integrity using machine learning aided DAS, according to some embodiments. As shown, system 100 includes DAS unit 110 communicatively coupled with at least one optical fiber 102 that is disposed along the pipeline 101. As shown in FIG. 1, optical fiber 102 is wound around pipeline 101 and configured to sense acoustic signals generated from locations along pipeline 101. In alternative embodiments, optical fiber 102 is arranged to extend along the pipeline without winding.

Pipeline 101 includes multiple locations 103a, 103b, 103c, and 103d, (collectively referred to as locations 103 and each individually referred to as location 103). Certain locations of pipeline 101 are equipped with repairs 111a, 111b, 111c, and 111d (collectively referred to as repairs 111 and each individually referred to as repair 111). In examples, repairs 111 are sections of pipeline covered by or equipped with, e.g., composite or metallic sleeves, repair clamps, or insulation coating, which are used to provide structural support to pipeline 102.

Optical fiber 102 captures acoustic signals generated by, e.g., hydrocarbon flow, water flow, or flow of other chemicals, through pipeline 101. In some embodiments, optical fiber 102 is coupled with a respective external surface of pipeline 101. A coherent laser pulse is sent along optical fiber 102, and scattering sites within the fiber cause optical fiber 102 to act as a distributed interferometer with a gauge length/spatial resolution approximately equal to the pulse length. The intensity of the reflected light is measured as a function of time after transmission of the laser pulse. When the pulse has had time to travel the full length of optical fiber 102 and back, the next laser pulse can be sent along optical fiber 102. Changes in the reflected intensity of successive pulses from the same region of fiber are caused by phase changes in the optical path of that section of optical fiber 102. The intensity of pulses is impacted by the acoustic signals produced by fluid flow through pipeline 101, and a machine learning model is trained to detect and quantify metal loss based on the captured acoustic signals. The captured acoustic signals vary based on an intensity and power of vibrations, and measurements can be made almost simultaneously at all sections of optical fiber 102.

The at least one optical fiber 102 is arranged along a variety of locations on the exterior of pipeline 101. In examples, optical fiber 102 is attached to the outer surface of bare metallic (e.g., steel) structure of a pipeline component (e.g., transport pile, tank, or vessel) that is not wrapped by a composite sleeve. Additionally, in examples, optical fiber 102 is attached to the composite sleeve (e.g., repairs 111) that wraps a pipeline component under repair. In embodiments, the composite sleeves are used to temporarily reinforce a defective pipeline section when immediate repair or replacement of the pipeline section is not available. Using traditional techniques, the composite sleeves can increase the difficulty of inspecting the integrity of pipelines. In embodiments, optical fiber 102 is attached to a metallic surface of pipeline 101 or attached to a composite sleeve covering pipeline 101 and data captured by optical fiber 102 is used to determine one or more locations with metal loss along pipeline 101.

Acoustic signals captured by at least one optical fiber 102 are transmitted to DAS unit 110 along the respective fiber. Upon receiving the acoustic signal, DAS unit 110, with the aid of a machine learning model, processes the acoustic signal to determine the integrity of pipeline 101 (e.g., a degree of metal loss). For example, DAS unit 110, which can include a computer having one or more hardware processors coupled to a memory, executes program instructions to input the acoustic signals to a machine learning model 104 for analysis. Machine learning model 104 is stored in the memory of DAS unit 110 or stored on a remote server that is communicatively coupled to DAS unit 110 via a wired or wireless network. In some embodiments, machine learning model 104 includes a convolutional neural network (CNN) trained to analyze the acoustic signal. However, other architectures of machine learning model 104, such as fully-connected artificial neural network (ANN), can be used in lieu of or in addition to the CNN in other embodiments.

Machine learning model 104 analyzes the continuous acoustic signal backscattered along the at least one optical fiber 102. Analysis results output by machine learning model 104 can be used, e.g., by one or more hardware processors of DAS unit 110 or another one or more computers, to determine existence of structural fault at the monitored locations caused by metal loss. For example, the analysis result obtained from machine learning model 104 can be used to determine, as a binary indicator, whether a structural fault is identified at one or more locations of pipeline 101. Alternatively, or additionally, the analysis result obtained from machine learning model 104 is used to determine, as a quantified, non-binary value, the thickness reduction caused by metal loss at the locations along the pipeline 101. As described above, location 103a, and likewise locations 103a-103d, can be locations with bare pipeline surface (e.g., metallic surface) or repair locations wrapped with, e.g., composite sleeves (e.g., repairs 111). As can be seen in FIG. 1, locations 103a and 103b are repair locations, whereas locations 103c and 103d are bare pipeline surface locations.

In some embodiments, machine learning model 104 has two or more branches, each separately performing an analysis using a representation of the provided acoustic signal. For example, machine learning model 104 includes a time-domain branch configured to perform a time-domain analysis using a time-domain representation of the acoustic signal, and also includes a frequency-domain branch configured to perform a frequency-domain analysis using a frequency-domain representation of the acoustic signal. Each branch of machine learning model 104 performs the respective analysis independently to the analyses performed by the other branches or sections, and the one or more hardware processors verify the accuracies of the analysis results from multiple branches. For example, the one or more hardware processors perform a logic AND operation between the binary indicators output by the time-domain branch and by the frequency-domain branch to determine whether the two indicators match. The one or more hardware processors can determine the existence of a structural fault when the two indicators match. Similarly, the one or more hardware processors can compare the quantified, non-binary values output by the time-domain branch and by the frequency-domain branch to determine whether the two values match. The one or more hardware processors can determine the degree of thickness reduction caused by metal loss when the two values match.

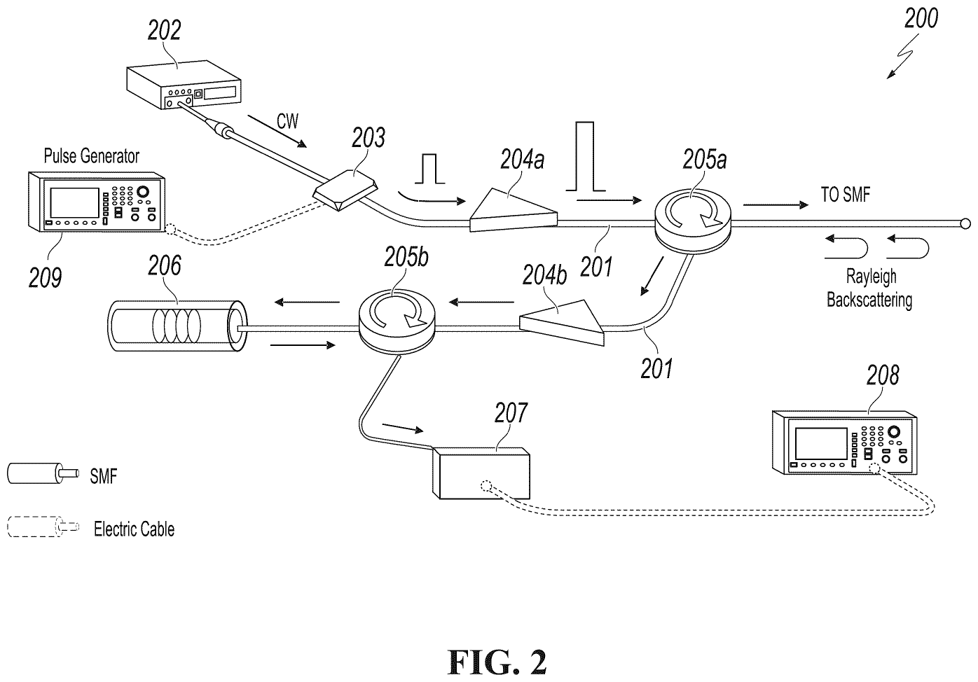

FIG. 2 illustrates an example DAS unit 200, according to some embodiments. In some embodiments, the DAS unit 200 is the same as or similar to DAS unit 110 of FIG. 1.

DAS unit 200 includes narrow linewidth laser generator 202 configured to generate continuous-wave (CW) light. DAS unit 200 also includes pulse generator 209 configured to generate a series of pulses. The CW light is modulated by acousto-optic modulator (AOM) 203 using the pulses generated by pulse generator 209. After modulation, the CW light pulse signal is amplified by erbium-doped fiber amplifier (EDFA) 204a and injected into a single-mode fiber (SMF) through circulator 205a. For ease of description, the present techniques are described using a single pipeline associated with a single-mode fiber. However, the present techniques can be implemented using a single-mode or multi-mode fiber-optic DAS, or DAS with other specialty optical fibers, that simultaneously monitors and detects metal loss in a multiple locations along a structure.

Due to Rayleigh backscattering at the SMF, some components of the CW light pulse signal are returned to circulator 205a, which circulates the returned signal (“Rayleigh signal”) to EDFA 204b and then, via circulator 205b, to fiber-Bragg grating (FBG) reflector 206. FBG reflector 206 is configured to filer the Rayleigh signal by removing amplified spontaneous emission (ASE). After filtering, the Rayleigh signal is circulated to and detected by partial discharge (PD) detector 207, and further sampled by data acquisition device (DAQ) 208. DAQ 208 is configured with a bandpass filter that removes, from the output of PD 207, low-frequency components typically associated with environmental noise and high-frequency components typically associated with electrical noise. In some embodiments where the spatial resolution of DAS unit 200 is about five meters, the sampling rate of DAQ 208 is about 10 kilohertz (kHz).

The sampling output from DAQ 208 represents the acoustic signal generated by resonation on a surface. In examples, the surface is made of metallic material, non-metallic material, or a combination of both. The surface can have a single layer or multiple layers. Accordingly, by coupling the SMF with a pipeline, DAS 200 captures acoustic signals generated by the pipeline along the sensing range (e.g., length) of the SMF.

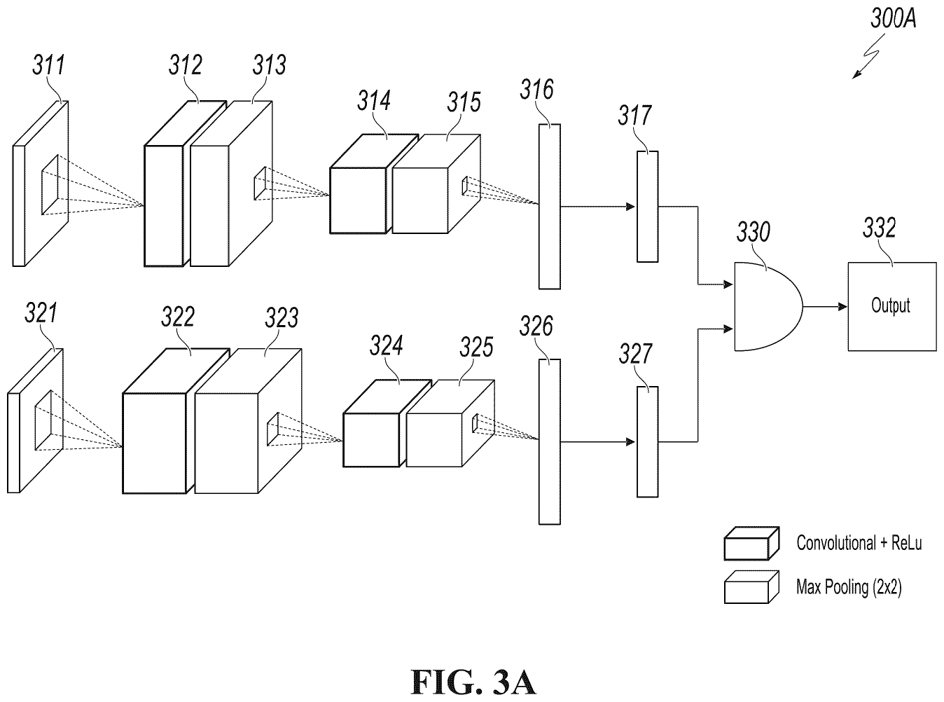

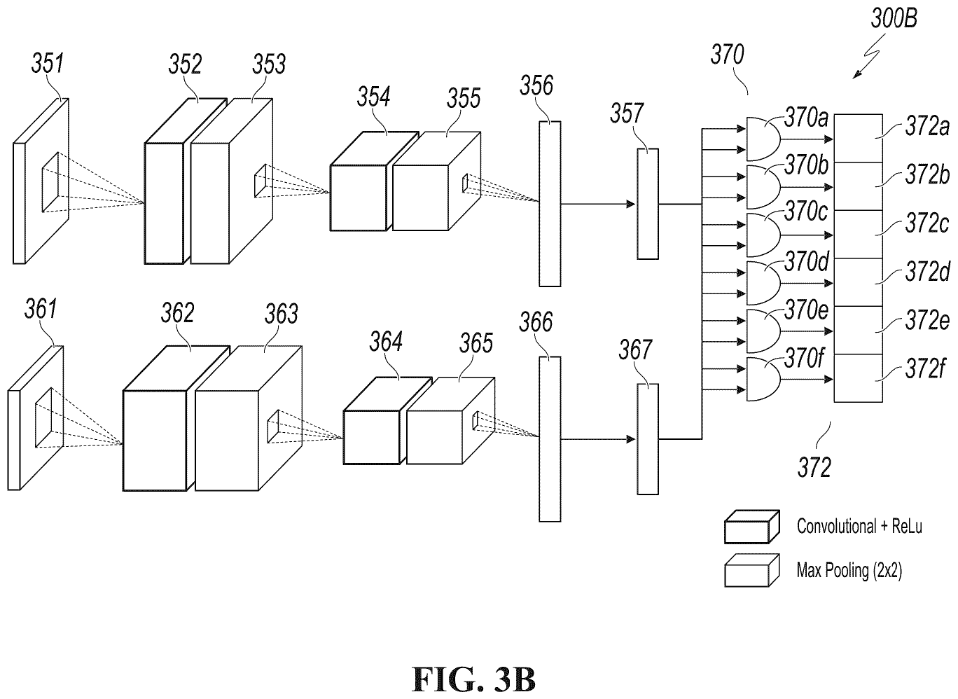

The acoustic signal obtained by DAS 200 is processed by a machine learning model, such as machine learning models 104 of FIG. 1. In some embodiments, the machine learning model can include a CNN trained to execute a time-domain analysis of the acoustic signal and a frequency-domain analysis of the acoustic signal. For example, the CNN includes a time-domain branch to perform the time-domain analysis and a frequency-domain branch to perform the frequency-domain analysis, with the two analyses performed independently to each other. Using the results of either or both analyses, one or more hardware processors determine the integrity of a pipeline monitored by DAS 200 based on the acoustic signal. As described above, the pipeline integrity can be measured by a binary indicator that indicates whether a structural fault is identified, and can be alternatively or additionally measured by a quantified, non-binary value that indicates the thickness reduction caused by metal loss. Example CNN architectures for performing the analyses are described below with reference to FIGS. 3A and 3B.

FIGS. 3A and 3B each illustrate an example architecture of a CNN for determining pipeline integrity, according to some embodiments. Architecture 300A of FIG. 3A is used to obtain the binary indicator, whereas architecture 300B of FIG. 3B is used to obtain the quantified, non-binary value. Architectures 300A and 300B can be separately implemented in two or more CNNs or can be implemented in the same CNN.

In FIG. 3A, architecture 300A has two branches for performing the analyses in the time domain and in the frequency domain, respectively. Results of the two branches can be combined and compared at logic circuit 330 to determine if the results match, and the comparison result is output at output layer 332.

The time-domain branch includes input layer 311, which receives a time-domain representation of acoustic signal obtained by a DAS unit, such as DAS unit 200. In the time domain, the acoustic signal can be represented as, e.g., the change of the sound/acoustic intensity with the time. The time-domain representation can provide valuable information, such as temporal patterns of intensity that serve as signatures to identify specific scenarios.

The time-domain representation is then provided to at least two pairs of convolutional and max pooling layers in series. The convolutional layers extract the various features from the input time-domain representation by performing a dot product between a portion of the input signal under analysis and a filter of a particular size. On the other hand, the pooling layers reduce the size of the convolved feature map representing the input time-domain representation, and thus, reduce computational costs. As shown in FIG. 3A, the first pair includes convolutional layer 312 and max pooling layer 313, and the second pair includes convolutional layer 314 and max pooling layer 315. The two pairs of convolutional and max pooling layers can have different sizes. In some embodiments, each of convolutional layers 312 and 314 is configured with a rectified linear unit (ReLU) activation function that has a plurality of filters.

After going through the pairs of convolutional and max pooling layers, the time-domain representation further goes through flattened layer 316 and dense layer (also known as fully connected layer) 317 active by a sigmoid function, which refers to a logistic function that receives a weighted sum of inputs and provides a binary indicator, e.g., with a value of ‘0’ or ‘1,’ that indicates a binary classification of the inputs. For example, after training, architecture 300A can classify the acoustic signal as coming from a location on the pipeline that either i) is intact (e.g., without structural fault due to metal loss) or ii) has metal loss.

As an example of the time-domain analysis, input layer 311 receives a time-domain vector representation with a dimension of 10×500. To process this vector, the ReLU of convolutional layer 312 is configured with 16 filters of a 3×50 size and a 1×1 stride, and the ReLU of convolutional layer 312 can be configured with 32 filters of a 3×3 size and a 1×1 stride. Max pooling layers 313 and 315 can each be configured with a 2×2 pool size.

The frequency-domain branch has similar architecture to the time-domain branch. As illustrated, the frequency-domain branch includes input layer 321, at least two pairs of convolutional and max pooling layers in series (shown as a first pair formed by convolutional layer 322 and max pooling layer 323 and a second pair formed by convolutional layer 324 and max pooling layer 325), flattened layer 326, and dense layer 327.

In examples, the frequency-domain vector representation in the frequency-domain analysis is based on acoustic signal obtained by a DAS unit, such as DAS unit 200. The input frequency-domain representation can be obtained by applying the fast Fourier transform (FFT) to the time-domain representation collected by the DAS unit. The frequency-domain representation includes, e.g., the distribution of the sound/acoustic power with the frequency, which can be a signature to the sound. When calculating the power spectral density through FFT, the values for the negative frequency components can be omitted. This can cause the dimension of the frequency-domain representation vector to be half of the dimension of the time-domain vector representation. For example, when the time-domain vector representation has dimension of 10×500, the corresponding frequency-domain vector representation can have a dimension of 10×250.

Similar to the result provided by dense layer 317 of the time-domain branch, the result provided by dense layer 327 is a binary indicator, that indicates a binary classification of the acoustic signal. The binary indicator indicates a classification of the acoustic signal as coming from a location on the pipeline that either i) is intact (e.g., without structural fault due to metal loss) or ii) has metal loss.

While the frequency-domain analysis and the time-domain analysis are both performed based on the same acoustic signal obtained by the DAS unit, the frequency-domain and time-domain analyses are performed independently to each other. For example, the frequency-domain branch can perform the frequency-domain analysis while being agnostic of the settings, parameters, and intermediate outputs of the time-domain branch, and the time-domain branch can perform the time-domain analysis while being agnostic of the settings, parameters, and intermediate outputs of the frequency-domain branch.

To improve the reliability of analysis, the binary indicators provided by dense layers 317 and 327 are provided to logic circuit 330 to verify whether the two binary indicators match. As an example, assuming the binary indicators use logic ‘0’ to indicate no detection of structural fault and use logic ‘1’ to indicate detection of structural fault, the two binary indicators can be provided to logic circuit 330 for a multiplication operation, which outputs logic ‘l’ only when both binary indicators have values of logic ‘1.’ In this example, architecture 300A indicates a detected structural fault at output layer 332 only when the structural fault is detected in both analyses.

In FIG. 3B, architecture 300B also has two branches for performing the analyses in the time domain and in the frequency domain, respectively. The time-domain branch and the frequency-domain branch of architecture 300B have structures similar to those of the time-domain branch and the frequency-domain branch of architecture 300A, respectively. For example, the time-domain branch of architecture 300B has input layer 351, a first pair of convolutional and max pooling layers 352 and 353, a second pair of convolutional and max pooling layers 354 and 355, flattened layer 356 and dense layer 357. Likewise, the frequency-domain branch of architecture 300B has input layer 361, a first pair of convolutional and max pooling layers 362 and 363, a second pair of convolutional and max pooling layers 364 and 365, flattened layer 366 and dense layer 367. Different from convolutional layers 312 and 322 of architecture 300A, which have 16 and 32 filters, respectively, convolutional layers 352 and 362 of architecture 300B both have 64 filters.

Instead of performing binary classifications, each branch of architecture 300B is configured to perform a multilabel classification based of the input acoustic signal. For example, the time-domain branch is configured to output, by a SoftMax function activated at dense layer 357, a vector having six binary elements, with each element representing a degree of metal loss. In a more specific example, the six elements can represent metal losses of 0 (i.e., no metal loss), 1 mm, 2 mm, . . . , and 5 mm. Dense layer 357 can be configured to set the value of an element to logic ‘1’ if the time-domain analysis finds the acoustic signal to result from a pipeline with a metal loss closest to a degree represented by that element. Similarly, the frequency-domain branch is configured to output another vector having six binary elements respectively representing the six degrees of metal loss.

The multi-element vectors output by the two branches are combined and compared at logic circuit 370, which includes logic circuits 370a, 370b, . . . 370f, to determine if the results match. The comparison results are output by output layer 370, which includes output ports 372a, 372b, . . . , and 372f. Each of logic circuits 370a, 370b, . . . 370f is configured to compare one of the six elements output by dense layers 357 and 367, and provide the comparison result for that element to a corresponding output port or output ports 372a, 372b, . . . , and 372f. The comparison of each element between two vectors is similar to the comparison between the binary indicators output by dense layers 317 and 327.

As an example, if the time-domain analysis performed by architecture 300B classifies the acoustic signal in the “2 mm” category, then dense layer 357 outputs a vector of (t1, t2, t3, t4, t5, t6)-(0, 0, 1, 0, 0, 0), which t1 to t6 representing no metal loss, 1 mm of metal loss, 2 mm of metal loss, 3 mm of metal loss, 4 mm of metal loss, and 5 mm of metal loss, respectively. Elements t1 to t6 are input to logic circuits 370a to 370f, respectively. Likewise, if the frequency-domain analysis performed by architecture 300B classifies the acoustic signal also in the “2 mm” category, then dense layer 367 outputs a vector of (f1, f2, f3, f4, f5, f6)=(0, 0, 1, 0, 0, 0), which f1 to f6 representing no metal loss, 1 mm of metal loss, 2 mm of metal loss, 3 mm of metal loss, 4 mm of metal loss, and 5 mm of metal loss, respectively. Elements f1 to f6 are also input to logic circuits 370a to 370f, respectively. With the inputs from both branches, logic circuits 370a to 370f can each perform a multiplication operation such that the output is logic ‘1’ only if both inputs to a logic circuit are logic ‘Is.’ In this example, the outputs by logic circuits 370a to 370f are 0, 0, 1, 0, 0, 0, respectively, which are then output by output layer 372 to indicate that both branches have determined that the acoustic signal mostly likely results from a pipeline with about 2 mm of metal loss.

Although both architectures 300A and 300B are described with two branches, some embodiments can have more than two branches. In addition, some embodiments can have one or more branches optionally turned off (e.g., not executing) to save computing resources. For example, either the time-domain branch or the frequency-domain branch in architectures 300A and 300B can be turned off, such that only one analysis is performed. Furthermore, although architecture 300B classifies the acoustic signal into six categories, some embodiments can be configured to have more categories to improve analysis accuracy, and some embodiments can be configured to have fewer categories to reduce computing complexity.

In embodiments, a machine learning model for determining pipeline integrity is trained via supervised learning, e.g., with output data already known based on the input training data. The training dataset is obtained by simulating the acoustic behavior using sounds emitted by pipes with different metal loss thicknesses and without metal loss. In examples, the simulation is based on computational fluid dynamics (CFD) model.

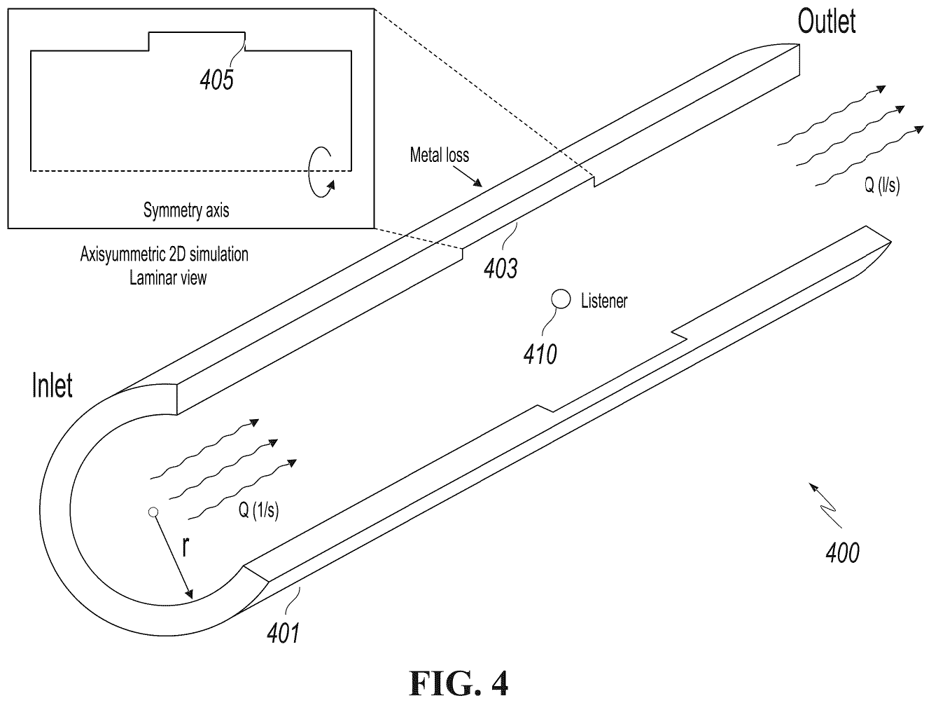

FIG. 4 illustrates an example schematic 400 for simulating the acoustic behavior of a pipeline with different degrees of metal loss, according to some embodiments. Schematic 400 represents the laminar view of a 3-inch-long (1 inch equals about 2.54 cm) gas pipe 401 with a 9 1/s inlet flow rate (Q), fluid density of 6 kg/m3, and viscosity of 1.1×10⁻⁵ kg/m.s. Inscribed in pipe 401 is a 1-inch-long section 403 including with a metal loss step height 405. The roughness of the internal surface of pipe 401 in the simulation is approximately the same as that of a steel pipe with moderate usage (about 575 μm). In examples, the simulation is configured to cover metal loss step height 405 with values equaling 0, 1 mm, 2 mm, . . . , and 5 mm. Additionally, the simulation has an outflow boundary condition set at pipe outlet to ensure the flow rate remains unchanged from the inlet to the outlet. Table 1 provides a set of example simulation parameters. In some embodiments, the simulation can assume pipe 401 is axisymmetric, which suggests that the results of the laminar view can be extrapolated to the rest of pipe 401 when rotating a two-dimensional geometry around a symmetry axis.

TABLE 1

| Parameter | Value |
|---|---|
| Fluid density (kg/m³) | 6 |
| Fluid viscosity (cp) | 0.011 |
| Flow rate (L/s) | 9 |
| Pipeline diameter (in) | 4 |
| Surface roughness (μm) | 575 |
| Metal loss thickness (mm) | 0, 1, 2, 3, 4, 5 |

To obtain the acoustic signal produced by pipe 401, detached eddy simulation (DES) is employed to generate the flow field inside pipe 401. This approach involves addressing the numerical solution of Navier-Stokes equations in the interior of pipe 401 using the large eddy simulation (LES) model, which divides the fluid motion into vertices of different sizes (“eddies”), and classifying the eddies by size into large- and small-scale eddies. The small-scale eddies are generally less affected by the flow fields than the large eddies. Therefore, the simulation ignores small eddies in calculations, thereby reducing the computational costs of the CFD simulation.

After filtering out the small eddies from the Navier-Stokes equations, LES provides an approximation of the fluid velocity spatial components by calculating averaged values, which simplifies the Navier-Stokes equations for compressible fluids (such as gas) to the following equations:

$$\frac{\partial \overline{ρ}}{\partial t} + \frac{\partial \overline{ρ} {\tilde{u}}_{j}^{*}}{\partial {x}_{j}} = 0. \\ \frac{\partial }{\partial t} ( \overline{ρ} {\tilde{u}}_{i}^{*} ) + \frac{\partial }{\partial {x}_{j}} ( \overline{ρ} {\tilde{u}}_{i}^{*} {\tilde{u}}_{j}^{*} ) + \frac{\partial {\overline{p}}^{*}}{\partial {x}_{i}} - \frac{\partial \tilde{{σ}_{ij}}}{\partial {x}_{j}} = - \frac{\partial }{\partial {x}_{j}} ( \overline{ρ} {τ}_{ij}^{r} ) .$$

In the simplified Navier-Stokes equations above, \tilde{μ}ᵢ* and \tilde{μ}ⱼ* are the spatial components of the Favre-filtered average fluid velocity

$$( \tilde{u} = \frac{\overline{ρ {u}^{*}}}{\overline{ρ}} )$$

in the î, ĵ bidimensional space, p̅* is the filtered average pressure vector, ρ̅ is the average fluid density, [symbol] is the Favre-filtered viscous stress tensor, xⱼ is the length component of pipe 401, τᵢⱼ^{r} is the filtered stress tensor (equivalent to [symbol] - [symbol] calculated by the Spalart-Allmaras model, and t is the time.

On the other hand, the internal surface of pipe 401, which is where metal losses occur, is the boundary layer of the geometry. To model the internal surface of pipe 401 with accuracy in the numerical solution, DES can simulate the flow field in the internal surface following Reynolds-averaged Navier-Stokes (RANS) equations for compressible flows (also known as Favre-averaged Navier-Stokes equations) that can be written as below:

$$\frac{\partial \overline{ρ}}{\partial t} + \frac{\partial \overline{ρ} {\tilde{u}}_{j}}{\partial {x}_{j}} = 0. \\ \frac{\partial }{\partial t} ( \overline{ρ} {\tilde{u}}_{i} ) + \frac{\partial }{\partial {x}_{j}} ( \overline{ρ} {\tilde{u}}_{i} {\tilde{u}}_{j} ) = - \frac{\partial p}{\partial {x}_{i}} + \frac{\partial \overline{{σ}_{ij}}}{\partial {x}_{j}} + \frac{\partial {τ}_{ij}}{\partial {x}_{j}} .$$

In the RANS equations above, [symbol] , [symbol] are the Favre-averaged fluid velocity components in the bidimensional space, p̅ is the average pressure vector, σ̅ᵢ̅ⱼ̅ is the averaged viscous stress tensor, and τᵢⱼ the Reynolds stress term defined as −ρ u̅′̅ᵢ̅u̅′̅ⱼ̅, where uᵢ′, uⱼ′ are the fluctuating parts of the Favre-averaged fluid velocity (u=ũ+u′).

After modeling the fluid field using DES, the acoustic signal is generated by transferring the distribution of fluid given by DES ( [symbol] , [symbol] ) to sound source (“listener”) 410. This is performed by using the Ffowcs Williams-Hawkings (FW-H) function. The FW-H function describes the noise generated by the interaction between a nonstationary solid boundary, such as the internal surface of the pipe walls, and a fluid medium, and can be expressed as follows:

$$\frac{1}{{a}_{0}^{2}} \frac{{\partial }^{2} {p}^{′}}{\partial {t}^{2}} - {∇}^{2} {p}^{′} = \frac{{\partial }^{2}}{\partial {x}_{i} \partial {x}_{j} 1} \{ {T}_{ij} H ( c ) \} - \frac{\partial }{\partial {x}_{j}} \{ [ {P}_{ij} {n}_{i} + ρ {u}_{j} ( {u}_{n} - {v}_{n} ) ] δ ( c ) \} + \frac{\partial }{\partial t} \{ [ {ρ}_{0} {v}_{n} + ρ ( {u}_{n} - {v}_{n} ) ] δ ( c ) \} .$$

In the FW-H function above, p′ is the sound pressure at far field, vₙ is the surface velocity component, α₀ and ρ₀ are the local sound speed and the local density, Tᵢⱼ is the Lighthill stress tensor, and H(c) is the Heaviside function. To analyze the sound pressure level (SPL) in dB (SPL=20 log₁₀(p′/P_{Ref}), with p_{ref}=2×10⁻⁵ Pa) obtained from the FW-H function, the pressure pulsation signal measured at the listener over time can be converted into the frequency domain using the Fast Fourier Transform (FFT).

Furthermore, the origin of the bidimensional space (i, j) is placed at the center point of the inlet. A Semi-Implicit Method for Pressure-Linked Equations (SIMPLE) scheme, which is an iterative algorithm used to solve the Navier-Stokes equations, can be chosen to iterate 60000 time-steps of 1×10⁻⁴ seconds each. For spatial discretization, Green-Gauss cell-based approach can be implemented, and the PREssure Staggering Option (PRESTO!) scheme, which is a discrete continuity balance to deal with the coupling between velocity and pressure fields, can be adopted to perform the pressure discretization. The bounded central differencing scheme can be chosen to generate the momentum terms, and the bounded second order implicit scheme can be used to generate the transient formulation.

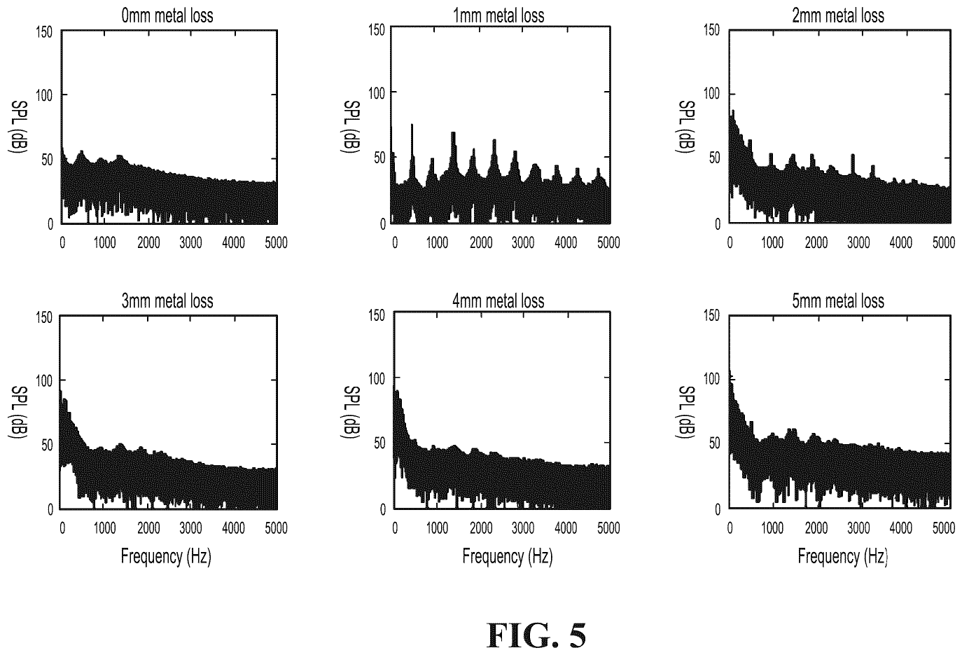

FIG. 5 illustrates example simulations results of SPLs for pipes with different degrees of metal loss, according to some embodiments. The simulation results can be obtained based on schematic 400 of FIG. 4 and with the parameters in Table 1. The six graphs in FIG. 5 represent results with metal loss equaling 0, 1 mm, 2 mm, . . . , and 5 mm, respectively.

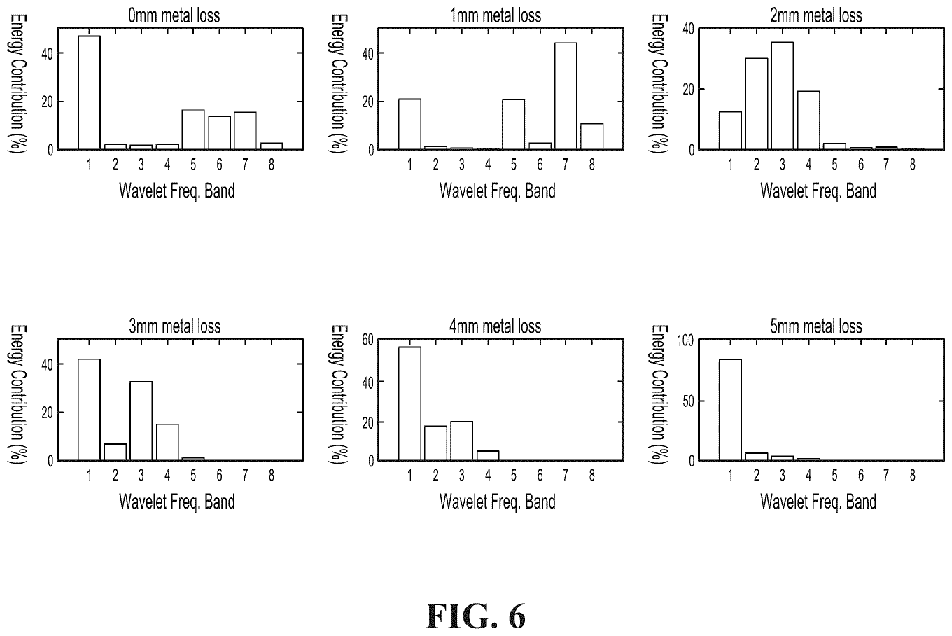

As can be observed from FIG. 5, in frequencies greater than 1 kHz, the differences in SPL between scenario of an intact pile (e.g., 0 metal loss) and scenarios with pipe metal losses. As frequency goes higher, continuous attenuation of SPL can be observed in all six graphs. The acoustic absorption caused by fluid viscosity is inversely proportional to the pipe wall thickness, and SPL generally accentuates as frequency increases. The observation from FIG. 5 can be further shown from a wavelet packet energy decomposition of the signals generated by CFD, which is explained below with reference to FIG. 6.

FIG. 6 illustrates example simulations results of energy contribution per frequency band for pipes with different degrees of metal loss, according to some embodiments. The simulation results can be obtained based on schematic 400 of FIG. 4 and with the parameters in Table 1. The six graphs in FIG. 6 represent results with metal loss equaling 0, 1 mm, 2 mm, . . . , and 5 mm, respectively. Each graph shows the energy contribution percentages of six wavelet frequency bands No. 1 to No. 6. The frequency ranges of bands No. 1 to No. 6 are given in Table 2.

TABLE 2

| Band | Initial Frequency (Hz) | End Frequency (Hz) |
|---|---|---|
| 0 | 0 | 39.1 |
| 1 | 39.1 | 78.1 |
| 2 | 78.1 | 156.2 |
| 3 | 156.2 | 312.5 |
| 4 | 312.5 | 625 |
| 5 | 625 | 1250 |
| 6 | 1250 | 2500 |
| 7 | 2500 | 5000 |

From FIG. 6, it can be observed that the energy contributions of bands 5, 6, 7, and 8 to the total energy of the acoustic signal decrease significantly when the metal loss becomes greater than 1 mm. This suggests that metal loss in faulty pipes (e.g., pipes with large values of metal losses) function as an acoustic low pass filter, with a cut-off frequency of approximately 625 Hz, corresponding to the initial frequency of band 5. Moreover, using band 6 as a example, the energy contribution decreases approximately exponentially from an incipient metal loss of 1 mm to a late stage metal loss of 5 mm. Given this observation, a bandpass filter can be applied to the acoustic signal in the CFD simulation.

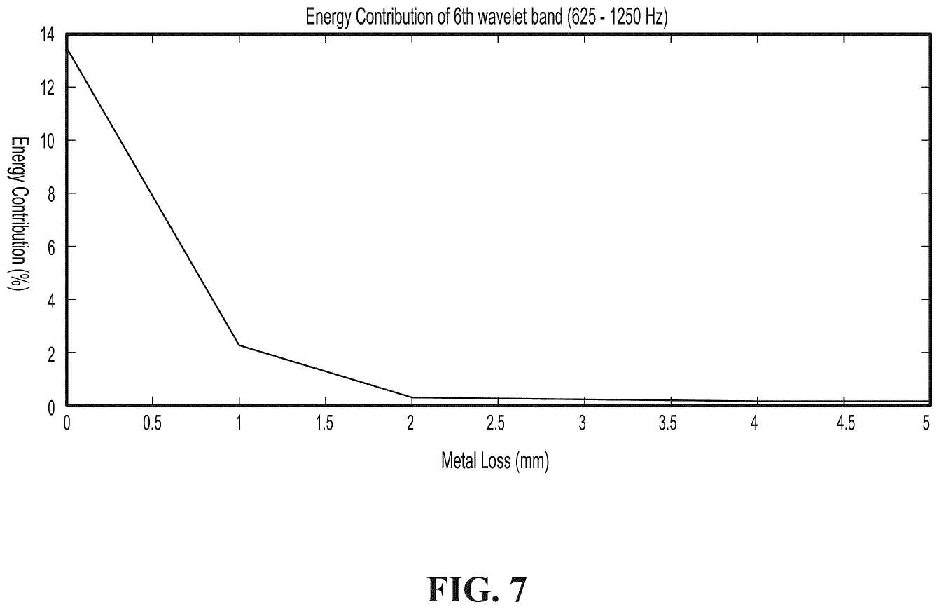

FIG. 7 illustrates an example graph showing the relationship between energy contribution and metal loss for band 6, according to some embodiments. The relationship, which is approximately exponential, can be similar to that described above with reference to FIG. 6.

Based on the relationship between band 6 energy contribution and the degree of metal loss, a bandpass filter with a passing band of about 100 Hz to 1250 Hz can be used by a DAS unit. The lower boundary of the passing band, about 100 Hz, is chosen to reduce the impact of environmental noise in the detection of acoustic signal, whereas the upper boundary of the passing band, about 1250 Hz, is the upper boundary of band 6.

The acoustic signal generated in the CFD simulation can be reproduced, by an acoustic signal generator such as a bone conduction speaker, along a pipe wound by an SMF. The acoustic signal generator converts the simulated acoustic signal to mechanical vibrations applied on the pipe, which is captured and transmitted along the SMF to create the acoustic signal set for training the machine learning model.

In examples, the training of the machine learning model involves a bare steel scenario, where the acoustic signal are reproduced at a location on the pipe surface, and a composite sleeve scenario, where the acoustic signal are reproduced at a location wrapped by a composite sleeve. In each scenario, the machine learning model is trained to classify acoustic signal in the time domain and in the frequency domain into one of two categories to indicate whether a structural fault is identified. In each scenario, the machine learning model is also be trained to classify acoustic signal in the time domain and in the frequency domain into one of more than two categories to indicate the degree of metal loss. The classifications performed by the trained machine learning model is similar to those described above with reference to FIGS. 3A and 3B.

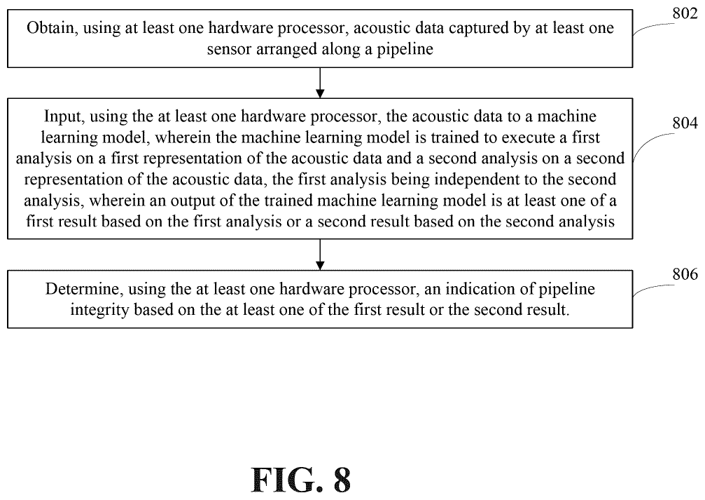

FIG. 8 illustrates a flowchart of an example method 800, according to some embodiments. Method 800 can be performed by, e.g., at least one hardware processor that is coupled to or part of a DAS unit configured to monitor pipeline integrity.

At 802, the at least one hardware processor obtains acoustic signal captured by at least one optical fiber arranged along a pipeline. The at least one optical fiber can be the same as or similar to at least one optical fiber 102 of system 100. In some embodiments, the at least one optical fiber is part of a DAS system that performs acoustic sensing along the pipeline.

At 804, the at least one hardware processor inputs the acoustic signal to a machine learning model, such as a CNN, which can be the same as or similar to machine learning model 104 of system 100. The machine learning model is trained to execute a first analysis on a first representation of the acoustic signal and a second analysis on a second representation of the acoustic signal, with the first analysis being independent to the second analysis. The first analysis can be a time-domain analysis and the second analysis can be a frequency-domain analysis. The trained machine learning model outputs at least one of a first result based on the first analysis or a second result based on the second analysis.

At 806, the at least one hardware processor determines an indication of pipeline integrity based on the at least one of the first result or the second result. The indication can include a binary indicator of whether a structural fault is identified, and/or a quantified, non-binary value representing a degree of metal loss.

As described above, embodiments of this disclosure use DAS and machine learning to monitor for metal loss and structural fault that risk pipeline integrity. When a structural fault or a degradation of pipeline integrity due to metal loss is detected at a location, the monitoring system can prompt a remedial measure to fix the damage. For example, in system 100 of FIG. 1, when the output of machine learning model 104 indicates a structural fault when processing acoustic signal obtained from optical fiber 102, a process of system 100 can determine that the structural fault takes place at location 103a and raises an alert. The alert can include, e.g., information about the degree of metal loss at location 103a and/or whether location 103a is bare steel or wrapped by a composite sleeve. Based on the information, system 100 can prompt one or more remedial measures. For example, when the metal loss is not severe (e.g., only 1 mm), system 100 can prompt the maintenance personnel to order a replacement part without shutting down pipeline 101. By contrast, when the metal loss is severe (e.g., 5 mm) and there is ongoing risk of pipeline failure, system 100 can prompt an emergency shutdown of pipeline 101 and immediately dispatch maintenance personnel to location 103a. Depending on whether location 103a is wrapped with a composite sleeve, system 100 can inform the maintenance personnel to order parts, carry equipment, and perform procedures accordingly. As such, the monitoring of pipeline integrity DAS and machine learning can improve the timeliness and accuracy of remedial measured needed to maintain pipeline integrity, thereby increasing the reliability and security of operation while reducing maintenance cost.

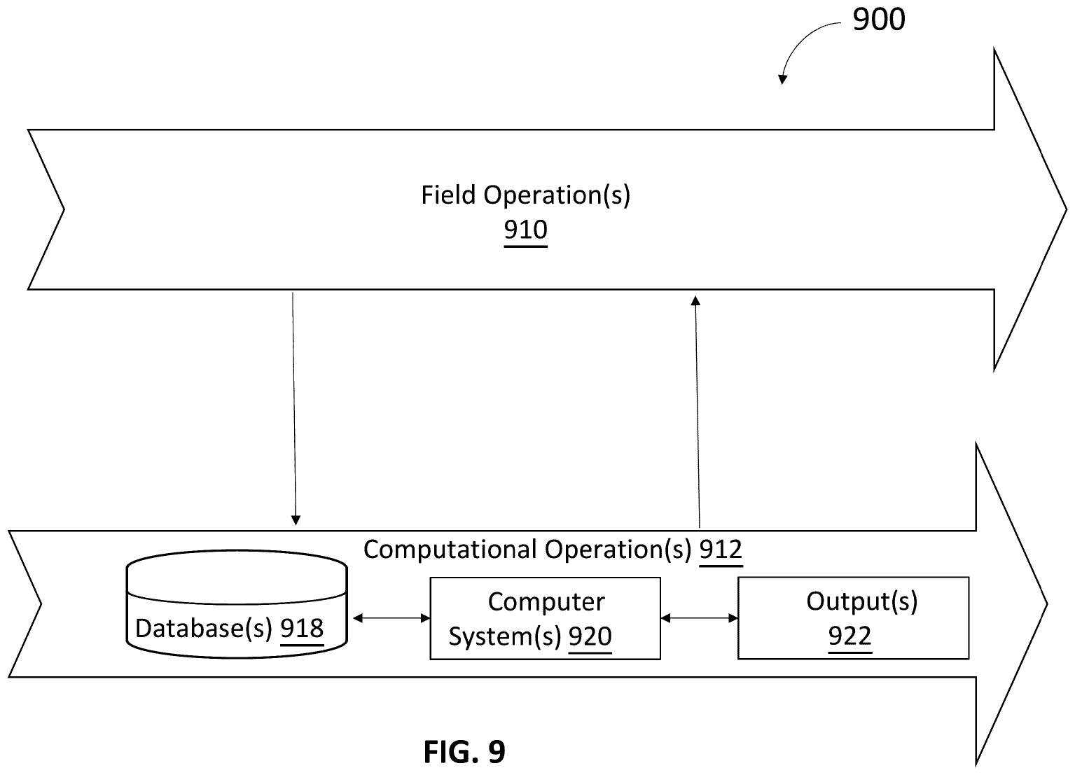

FIG. 9 illustrates hydrocarbon production operations 900 that include both one or more field operations 910 and one or more computational operations 912, which exchange information and control exploration for the production of hydrocarbons. In some embodiments, outputs of techniques of the present disclosure can be performed before, during, or in combination with the hydrocarbon production operations 900, specifically, for example, either as field operations 910 or computational operations 912, or both. For example, the monitoring of pipeline integrity using DAS, as described above, can take place before, during, or in combination with the hydrocarbon production operations 900.

Examples of field operations 910 include forming/drilling a wellbore, hydraulic fracturing, producing through the wellbore, injecting fluids (such as water) through the wellbore, to name a few. In some embodiments, methods of the present disclosure can trigger or control the field operations 910. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 910 and responsively triggering the field operations 910 including, for example, generating plans and signals that provide feedback to and control physical components of the field operations 910. Alternatively, or in addition, the field operations 910 can trigger the methods of the present disclosure. For example, implementing physical components (including, for example, hardware, such as sensors) deployed in the field operations 910 can generate plans and signals that can be provided as input or feedback (or both) to the methods of the present disclosure.

Examples of computational operations 912 include one or more computer systems 920 that include one or more processors and computer-readable media (e.g., non-transitory computer-readable media) operatively coupled to the one or more processors to execute computer operations to perform the methods of the present disclosure. The computational operations 912 can be implemented using one or more databases 918, which store data received from the field operations 910 and/or generated internally within the computational operations 912 (e.g., by implementing the methods of the present disclosure) or both. For example, the one or more computer systems 920 process inputs from the field operations 910 to assess conditions in the physical world, the outputs of which are stored in the databases 918. For example, seismic sensors of the field operations 910 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 912 where they are stored in the databases 918 and analyzed by the one or more computer systems 920.

In some embodiments, one or more outputs 922 generated by the one or more computer systems 920 can be provided as feedback/input to the field operations 910 (either as direct input or stored in the databases 918). The field operations 910 can use the feedback/input to control physical components used to perform the field operations 910 in the real world.

For example, the computational operations 912 can process the seismic data to generate three-dimensional (3D) maps of the subsurface formation. The computational operations 912 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 912 to process new information about the formation and control the drilling to adjust to the observed conditions in real-time.

The one or more computer systems 920 can update the 3D maps of the subsurface formation as information from one exploration well is received and the computational operations 912 can adjust the location of the next exploration well based on the updated 3D maps. Similarly, the data received from production operations can be used by the computational operations 912 to control components of the production operations. For example, production well and pipeline data can be analyzed to predict slugging in pipelines leading to a refinery and the computational operations 912 can control machine operated valves upstream of the refinery to reduce the likelihood of plant disruptions that run the risk of taking the plant offline.

In some embodiments of the computational operations 912, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some embodiments, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some embodiments, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

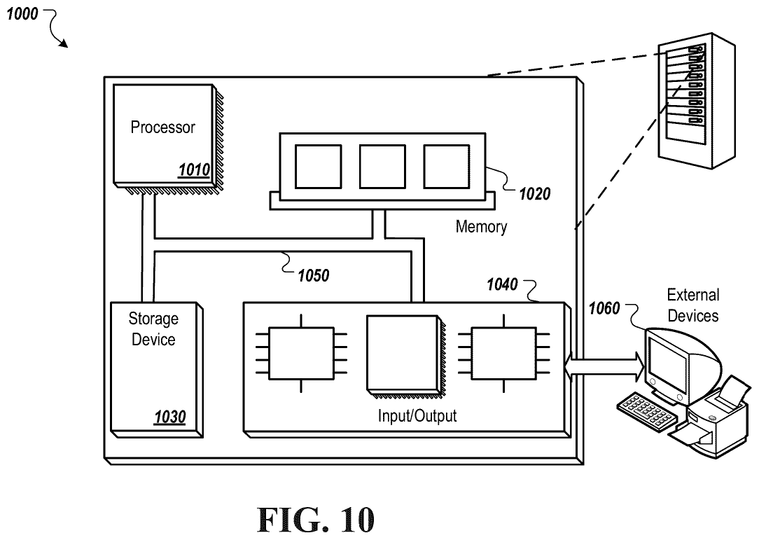

FIG. 10 is a block diagram of an example computer system 1000 according to some embodiments. The system 1000 includes a processor 1010, a memory 1020, a storage device 1030, and one or more input/output interface devices 1040. Each of the components 1010, 1020, 1030, and 1040 can be interconnected, for example, using a system bus 1050.

The processor 1010 is capable of processing instructions for execution within the system 1000. The term “execution” as used here refers to a technique in which program code causes a processor to carry out one or more processor instructions. In some embodiments, the processor 1010 is a single-threaded processor. In some embodiments, the processor 1010 is a multi-threaded processor. The processor 1010 is capable of processing instructions stored in the memory 1020 or on the storage device 1030. The processor 1010 may execute operations such as those described with reference to other figures described herein. For example, the processor 1010 can include at least one hardware processor configured to perform the operations of method 800 of FIG. 8.

The memory 1020 stores information within the system 1000. In some embodiments, the memory 1020 is a computer-readable medium. In some embodiments, the memory 1020 is a volatile memory unit. In some embodiments, the memory 1020 is a non-volatile memory unit.

The storage device 1030 is capable of providing mass storage for the system 1000. In some embodiments, the storage device 1030 is a non-transitory computer-readable medium. In various different embodiments, the storage device 1030 can include, for example, a hard disk device, an optical disk device, a solid-state drive, a flash drive, magnetic tape, or some other large capacity storage device. In some embodiments, the storage device 1030 may be a cloud storage device, e.g., a logical storage device including one or more physical storage devices distributed on a network and accessed using a network. In some examples, the storage device may store long-term data. The input/output interface devices 1040 provide input/output operations for the system 1000. In some embodiments, the input/output interface devices 1040 can include one or more of a network interface devices, e.g., an Ethernet interface, a serial communication device, e.g., an RS-232 interface, and/or a wireless interface device, e.g., an 802.11 interface, a 3G wireless modem, a 4G wireless modem, a 5G wireless modem, etc. A network interface device allows the system 1000 to communicate, for example, transmit and receive data. In some embodiments, the input/output device can include driver devices configured to receive input data and send output data to other input/output devices, e.g., keyboard, printer and display devices 1060. In some embodiments, mobile computing devices, mobile communication devices, and other devices can be used.

A server can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 1000 is contained within a single integrated circuit package. A system 1000 of this kind, in which both a processor 1010 and one or more other components are contained within a single integrated circuit package and/or fabricated as a single integrated circuit, is sometimes called a microcontroller. In some embodiments, the integrated circuit package includes pins that correspond to input/output ports, e.g., that can be used to communicate signals to and from one or more of the input/output interface devices 1040.

Although an example processing system has been described in FIG. 10, embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software embodiments of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. In an example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “computing device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some embodiments, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as standalone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some embodiments, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a GNSS sensor or receiver, or a portable storage device such as a universal serial bus (USB) flash drive.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

### Examples

In an example implementation, a method for monitoring pipeline integrity includes: obtaining, using at least one hardware processor, acoustic signal captured by at least one optical fiber arranged along a pipeline, wherein the at least one optical fiber is coupled with a distributed acoustic sensing (DAS) system; inputting, using the at least one hardware processor, the acoustic signal to a machine learning model, wherein the machine learning model is trained to execute a first analysis on a first representation of the acoustic signal and a second analysis on a second representation of the acoustic signal, the first analysis being independent to the second analysis, wherein an output of the trained machine learning model is at least one of a first result based on the first analysis or a second result based on the second analysis; and determining, using the at least one hardware processor, an indication of pipeline integrity based on the at least one of the first result or the second result.

In an aspect combinable with the example implementation, the first analysis includes a time-domain analysis, and the second analysis includes a frequency-domain analysis.

In another aspect combinable with any of the previous aspects, the machine learning model includes a convolutional neural network (CNN) having a time-domain branch trained to perform the time-domain analysis and a frequency-domain branch trained to perform the frequency-domain analysis. The time-domain branch includes: a first input layer configured to receive a time-domain representation of the acoustic signal; at least two first pairs of convolutional and max pooling layers; a first flattened layer; a first dense layer; and a first output layer configured to output the first result. The frequency-domain branch includes: a second input layer configured to receive a frequency-domain representation of the acoustic signal; at least two second pairs of convolutional and max pooling layers; a second flattened layer; a second dense layer; and a second output layer configured to output the second result. In some cases, determining the indication of pipeline integrity includes verifying that the first result matches the second result.

In another aspect combinable with any of the previous aspects, the indication includes at least one of: a binary value indicating existence of a structural fault on the pipeline, or a non-binary value indicating a degree of metal loss on the pipeline.

In another aspect combinable with any of the previous aspects, the method includes training the machine learning model using a training dataset in a supervised manner. In some cases, the training dataset includes simulated data obtained from a computational fluid dynamics (CFD) simulation of sound pressure levels at simulated pipelines based on a metal thickness of the simulated pipelines.

In another aspect combinable with any of the previous aspects, the at least one optical fiber includes at least one of a single-mode optical fiber or a multi-mode optical fiber.

In another aspect combinable with any of the previous aspects, the at least one optical fiber is attached to a metallic surface of the pipeline or attached to a composite sleeve covering the pipeline.

In another aspect combinable with any of the previous aspects, the method includes identifying, based on the indication, a location of a damage to the pipeline; and prompting a remedial measure to fix the damage at the location.

In another example implementation, a non-transitory computer-readable medium stores program instructions that, when executed, cause at least one hardware processor to perform operations for monitoring pipeline integrity. The operations include: obtaining acoustic signal captured by at least one optical fiber arranged along a pipeline, wherein the at least one optical fiber is coupled with a distributed acoustic sensing (DAS) system; inputting the acoustic signal to a machine learning model, wherein the machine learning model is trained to execute a first analysis on a first representation of the acoustic signal and a second analysis on a second representation of the acoustic signal, the first analysis being independent to the second analysis, wherein an output of the trained machine learning model is at least one of a first result based on the first analysis or a second result based on the second analysis; and determining an indication of pipeline integrity based on the at least one of the first result or the second result.

In an aspect combinable with the example implementation, the first analysis includes a time-domain analysis, and the second analysis includes a frequency-domain analysis.

In another aspect combinable with any of the previous aspects, the machine learning model includes a convolutional neural network (CNN) having a time-domain branch trained to perform the time-domain analysis and a frequency-domain branch trained to perform the frequency-domain analysis. The time-domain branch includes: a first input layer configured to receive a time-domain representation of the acoustic signal; at least two first pairs of convolutional and max pooling layers; a first flattened layer; a first dense layer; and a first output layer configured to output the first result. The frequency-domain branch includes: a second input layer configured to receive a frequency-domain representation of the acoustic signal; at least two second pairs of convolutional and max pooling layers; a second flattened layer; a second dense layer; and a second output layer configured to output the second result. In some cases, determining the indication of pipeline integrity includes verifying that the first result matches the second result.

In another aspect combinable with any of the previous aspects, the indication includes at least one of: a binary value indicating existence of a structural fault on the pipeline, or a non-binary value indicating a degree of metal loss on the pipeline.

In another aspect combinable with any of the previous aspects, the operations include training the machine learning model using a training dataset in a supervised manner. In some cases, the training dataset includes simulated data obtained from a computational fluid dynamics (CFD) simulation of sound pressure levels at simulated pipelines based on a metal thickness of the simulated pipelines.

In another aspect combinable with any of the previous aspects, the at least one optical fiber includes at least one of a single-mode optical fiber or a multi-mode optical fiber.

In another aspect combinable with any of the previous aspects, the at least one optical fiber is attached to a metallic surface of the pipeline or attached to a composite sleeve covering the pipeline.

In another example implementation, a system for monitoring pipeline integrity includes: at least one optical fiber arranged along a pipeline; and at least one hardware processor, wherein the at least one hardware processor is configured to perform operations including: obtaining acoustic signal captured by the at least one optical fiber; inputting the acoustic signal to a machine learning model, wherein the machine learning model is trained to execute a first analysis on a first representation of the acoustic signal and a second analysis on a second representation of the acoustic signal, the first analysis being independent to the second analysis, wherein an output of the trained machine learning model is at least one of a first result based on the first analysis or a second result based on the second analysis; and determining an indication of pipeline integrity based on the at least one of the first result or the second result.

While this specification includes many specific embodiment details, these should not be construed as limitations on the scope of what may be claimed, but rather as descriptions of features that may be specific to particular embodiments. Certain features that are described in this specification in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described embodiments should not be understood as requiring such separation or integration in all embodiments, and it should be understood that the described program components and systems can generally be integrated together in a single software product or packaged into multiple software products.

Accordingly, the previously described example embodiments do not define or constrain the present disclosure. Other changes, substitutions, and alterations are also possible without departing from the spirit and scope of the present disclosure.

What is claimed is:

1. A method for monitoring pipeline integrity, comprising:
obtaining, using at least one hardware processor, acoustic signal captured by at least one optical fiber arranged along a pipeline, wherein the at least one optical fiber is coupled with a distributed acoustic sensing (DAS) system;
inputting, using the at least one hardware processor, the acoustic signal to a machine learning model, wherein the machine learning model is trained to execute a first analysis on a first representation of the acoustic signal and a second analysis on a second representation of the acoustic signal, the first analysis being independent to the second analysis, wherein an output of the trained machine learning model is at least one of a first result based on the first analysis or a second result based on the second analysis; and
determining, using the at least one hardware processor, an indication of pipeline integrity based on the at least one of the first result or the second result.

2. The method of claim 1, wherein the first analysis comprises a time-domain analysis, and the second analysis comprises a frequency-domain analysis.

3. The method of claim 2,
wherein the machine learning model comprises a convolutional neural network (CNN) having a time-domain branch trained to perform the time-domain analysis and a frequency-domain branch trained to perform the frequency-domain analysis,
wherein the time-domain branch comprises:
a first input layer configured to receive a time-domain representation of the acoustic signal;
at least two first pairs of convolutional and max pooling layers;
a first flattened layer;
a first dense layer; and
a first output layer configured to output the first result, and
wherein the frequency-domain branch comprises:
a second input layer configured to receive a frequency-domain representation of the acoustic signal;
at least two second pairs of convolutional and max pooling layers;
a second flattened layer;
a second dense layer; and
a second output layer configured to output the second result.

4. The method of claim 3, wherein determining the indication of pipeline integrity comprises verifying that the first result matches the second result.

5. The method of claim 1, wherein the indication comprises at least one of: a binary value indicating existence of a structural fault on the pipeline, or a non-binary value indicating a degree of metal loss on the pipeline.

6. The method of claim 1, further comprising training the machine learning model using a training dataset in a supervised manner.

7. The method of claim 6, wherein the training dataset comprises simulated data obtained from a computational fluid dynamics (CFD) simulation of sound pressure levels at simulated pipelines based on a metal thickness of the simulated pipelines.

8. The method of claim 1, wherein the at least one optical fiber comprises at least one of a single-mode optical fiber or a multi-mode optical fiber.

9. The method of claim 1, wherein the at least one optical fiber is attached to a metallic surface of the pipeline or attached to a composite sleeve covering the pipeline.

10. The method of claim 1, further comprising:
identifying, based on the indication, a location of a damage to the pipeline; and
prompting a remedial measure to fix the damage at the location.

11. A non-transitory computer-readable medium storing program instructions that, when executed, cause at least one hardware processor to perform operations for monitoring pipeline integrity, the operations comprising:
obtaining acoustic signal captured by at least one optical fiber arranged along a pipeline, wherein the at least one optical fiber is coupled with a distributed acoustic sensing (DAS) system;
inputting the acoustic signal to a machine learning model, wherein the machine learning model is trained to execute a first analysis on a first representation of the acoustic signal and a second analysis on a second representation of the acoustic signal, the first analysis being independent to the second analysis, wherein an output of the trained machine learning model is at least one of a first result based on the first analysis or a second result based on the second analysis; and
determining an indication of pipeline integrity based on the at least one of the first result or the second result.

12. The non-transitory computer-readable medium of claim 11, wherein the first analysis comprises a time-domain analysis, and the second analysis comprises a frequency-domain analysis.

13. The non-transitory computer-readable medium of claim 12,
wherein the machine learning model comprises a convolutional neural network (CNN) having a time-domain branch trained to perform the time-domain analysis and a frequency-domain branch trained to perform the frequency-domain analysis,
wherein the time-domain branch comprises:
a first input layer configured to receive a time-domain representation of the acoustic signal;
at least two first pairs of convolutional and max pooling layers;
a first flattened layer;
a first dense layer; and
a first output layer configured to output the first result, and
wherein the frequency-domain branch comprises:
a second input layer configured to receive a frequency-domain representation of the acoustic signal;
at least two second pairs of convolutional and max pooling layers;
a second flattened layer;
a second dense layer; and
a second output layer configured to output the second result.

14. The non-transitory computer-readable medium of claim 13, wherein determining the indication of pipeline integrity comprises verifying that the first result matches the second result.

15. The non-transitory computer-readable medium of claim 11, wherein the indication comprises at least one of: a binary value indicating existence of a structural fault on the pipeline, or a non-binary value indicating a degree of metal loss on the pipeline.

16. The non-transitory computer-readable medium of claim 11, the operations further comprising training the machine learning model using a training dataset in a supervised manner.

17. The non-transitory computer-readable medium of claim 16, wherein the training dataset comprises simulated data obtained from a computational fluid dynamics (CFD) simulation of sound pressure levels on the pipeline based on a metal thickness of simulated pipelines.

18. The non-transitory computer-readable medium of claim 11, wherein the at least one optical fiber comprises a single-mode optical fiber.

19. The non-transitory computer-readable medium of claim 11, wherein the at least one optical fiber is attached to a metallic surface of the pipeline or attached to a composite sleeve covering the pipeline.

20. A system for monitoring pipeline integrity, comprising:
at least one optical fiber arranged along a pipeline; and
at least one hardware processor,
wherein the at least one hardware processor is configured to perform operations comprising:
obtaining acoustic signal captured by the at least one optical fiber;
inputting the acoustic signal to a machine learning model, wherein the machine learning model is trained to execute a first analysis on a first representation of the acoustic signal and a second analysis on a second representation of the acoustic signal, the first analysis being independent to the second analysis, wherein an output of the trained machine learning model is at least one of a first result based on the first analysis or a second result based on the second analysis; and
determining an indication of pipeline integrity based on the at least one of the first result or the second result.
